(19) United States
(12) Patent Application Publication
(10) Pub. No.: US 2020/0353422 A1
(43) Pub. Date: Nov. 12, 2020

(54) MEMBRANE MODULES WITH LIMITED DEFECTS AND RELATED METHODS

(71) Applicant: Nanostone Water Inc., Waltham, MA (US)

(72) Inventor: Christian Goebbert, Eschau (DE)

(21) Appl. No.: 16/959,229

(22) PCT Filed: Dec. 21, 2018
(86) PCT No.: PCT/EP2018/086649

§ 371 Date: Jun. 30, 2020

Related U.S. Application Data
(60) Provisional application No. 62/617,941, filed on Jan. 16, 2018.

(51) Int. Cl. B01D 65/10; B01D 63/06; B01D 69/06; B01D 71/02; B28B 3/20; B28B 11/24

(52) U.S. Cl. CPC B01D 65/102; B01D 63/061; B01D 63/066; B01D 69/06; B01D 65/104; B28B 2003/203; B28B 3/20; B28B 11/243; B01D 2313/04; B01D 2319/04; B01D 71/02

(57) ABSTRACT

A module includes flat ceramic segments, a potting material and a housing. The module exhibits relatively low pressure decay. A method for preparing such a module is provided.

### TECHNICAL FIELD

A water filtration assembly with limited defects and related methods.

### TECHNICAL BACKGROUND

Many waters contain contaminants that can present a hazard to people or the environment. Membranes are commonly used to remove such contaminants Membrane elements are typically made of plastics, polymers or ceramics, both of which are frequently placed inside a housing to contain the pressurized fluid to be treated. Typically ends of the membranes are potted to form a membrane module. The membrane modules are later tested for defects. When the testing occurs after potting, the entire module is determined to either be acceptable or unacceptable, and the unacceptable modules are no longer usable. Furthermore, current ceramic modules have difficulty in realizing low defect incidence. Still further, current processes of ceramic modules focus has been on plugging defects, or using thick coating layers with reduced water permeability.

In the past, ceramic modules have been made with numerous small channels in a cylindrical configuration. The segments are made by extruding a green body containing water. More recently ceramic segments have been made by using flat segments with multiple rows of channels. When extruded, the flat segments are typically placed on a flat support.

### SUMMARY

The disclosure seeks to provide modules that exhibit relatively good integrity, such as displayed, for example, by relatively low pressure decay as described herein. The disclosure also seeks to provide methods of making and using such modules.

Pressure decay is a metric that gives an indication of the amount of defects in a membrane. The magnitude of the rate of air passage gives an indication of quantity of defects, and the size of the defects being determined by the pressure being applied. The measured rate of pressure decay over a period of time will also depend on the volume of air at the high pressure. A larger volume of compressed air will decay less with the same volume of air passage through defects. In use defect passage in a membrane is offset by passage of water through good regions of membrane which results in a dilution of the contaminants that may be passing through the defects. An increase in the area leads to more water passing through good regions and dilutes the relative contribution through defects. As a result of the effects of membrane area A, and pressurized volume V, the following equation can be used to determine if a given pressure decay rate D is acceptable:

D*V/A=Δ

Where Δ is the design independent pressure decay. This can be rearranged to determine an acceptable decay rate based on a specific membrane design:

D=ΔA/V

In this document A is in units of square meters, V in units of liters, and Δ in units of mBar*liters/(m²*min). Of course other units could be used with the value of Δ changing along with the units.

In general, the design independent pressure decay is measured at a particular temperature. Unless otherwise indicated herein, the design independent pressure decay values provided are measured at 25° C.

In some embodiments, the disclosure provides a module that includes: at least two individual flat ceramic segments including rows of channels with more than one channel per row; potting material holding the at least two individual flat ceramic segments together; and a housing holding the at least two individual flat ceramic segments and the potting material. The housing, potting material and at least two individual flat segments define a filtration module. The module is configured to be capable of providing a design independent pressure decay of less than 36 mBar*liters/m²*min when measured according to the following test method: wetting the ceramic and completely removing entrained air; applying air at a pressure of 1 bar to a port of the housing; and turning off the air supply to the port and measuring the design independent pressure decay in the channels a temperature of 25° C. In certain embodiments, the module can be configured to be capable of providing a design independent pressure decay of less than 18 mBar*liters/m²*min (e.g., less than 9.1 mBar*liters/m²*min according to the test method, less than 4.5 mBar*liters/m²*min).

In some embodiments, the disclosure provides a monolithic filtration module including a plurality of separate ceramic segments held in a housing via a potting material. The module is configured to be capable of providing a design independent pressure decay of less than 36 mBar*liters/m²*min when measured according to the following method: wetting the ceramic and completely removing entrained air; applying air at a pressure of 1 bar to a port of the housing; and turning off the air supply to the port and measuring the design independent pressure decay in the channels a temperature of 25° C. In some embodiments, the module can be configured to be capable of providing a design independent pressure decay of less than 18 mBar*liters/m²*min (e.g., less than 9.1 mBar*liters/m²*min, less than 4.5 mBar*liters/m²*min).

In some embodiments, the disclosure provides a module that includes: at least two individual flat ceramic segments including rows of channels with more than one channel per row; potting material holding the at least two individual flat ceramic segments together; and a housing holding the at least two individual flat ceramic segments and the potting material. The housing, potting material and at least two individual flat segments define a filtration module. The module is configured to be capable of providing a design independent pressure decay of less than 36 mBar*liters/m²*min when measured according to the following method: wetting the segments; applying air to the channels at a pressure of above 0.1 bar when an outside portion of the segments is open to atmospheric conditions; stopping air supply to the channels; and measuring the design independent pressure decay through the segments at a temperature of 25° C. In some embodiments, the module can be configured to be capable of providing a design independent pressure decay of less than 18 mBar*liters/m²*min (e.g., less than 9.1 mBar*liters/m²*min, less than 4.5 mBar*liters/m²*min). In some embodiments, the method can include applying air to the channels at a pressure of above 0.5 bar (e.g., above 0.75 bar, above 1.0 bar) when an outside portion of the segments is open to atmospheric conditions.

In some embodiments, the disclosure provides a monolithic filtration module that includes a plurality of separate ceramic segments held in a housing via a potting material. The module is configured to be capable of providing a design independent pressure decay of less than 36 mBar*liters/m²*min when measured according to the following method: wetting the segments; applying air to the channels at a pressure of above 0.1 bar when an outside portion of the segments is open to atmospheric conditions; stopping air supply to the channels; and measuring the design independent pressure decay through the segments at a temperature of 25° C. In some embodiments, the module can be configured to be capable of providing a design independent pressure decay of less than 18 mBar*liters/m²*min (e.g., less than 9.1 mBar*liters/m²*min, less than 4.5 mBar*liters/m²*min). In some embodiments, the method can include applying air to the channels at a pressure of above 0.5 bar (e.g., above 0.75 bar, above 1.0 bar) when an outside portion of the segments is open to atmospheric conditions.

In some embodiments, the disclosure provides a method for preparing a ceramic, flat segmented module having individual segments. The individual segments have more than one row of channels and more than one channel per row, and the individual segments are defined by an outside portion. The method includes: categorizing individual segments into at least two categories based on occurrence of defects that affect field performance, where categorizing the segments occurs before assembly of the segments, each of the segments extending from a first end to a second end; assembling the individual segments primarily from one category of the at least two categories and forming assembled segments; potting the assembled segments together; and disposing the potted segments into a housing with at least two ports, with at least one first port bing a fluid treatment entry port, at least one second port being a treated fluid delivery port.

The method can further including testing the individual segments prior to categorizing the individual segments. Testing the individual segments can include wetting the segments, applying air to the channels at a pressure of above 0.1 bar to the channels, the outside portion of the segments being open to atmospheric conditions, stopping air supply to the channels, and measuring a rate of pressure decay in the channels.

In some embodiments, the individual segments are categorized based on a design independent pressure decay of less than 36 mBar*liters/m²*min (e.g., less than 18 mBar*liters/m²*min, less than 9.1 mBar*liters/m²*min, less than 4.5 mBar*liters/m²*min) as determined at 25° C.

In some embodiments, testing the individual segments includes wetting the segments, applying air to the channels at a pressure of above 0.1 bar to the first end of the segments, the outside portion of the segments being open to atmospheric conditions, and measuring a gas flow rate in the channels.

In some embodiments, testing the individual segments includes wetting the segments, immersing the segment in a test liquid, applying air to the channels, and verifying an absence of air passage at a pressure equal or greater than 0.1 Bar.

In some embodiments, the individual segments are categorized based on the presence or absence of air passage at a pressure equal or greater than 0.5 Bar (e.g., a pressure equal or greater than 0.7 Bar, a pressure of 0.9-1.1 Bar.

In some embodiments, the method further includes drying the individual segments on a flat porous support having a porosity of greater than 20% (e.g., greater than 50%, 60%-95%) when compressed with a force of 2.45×10⁻⁵ kN/cm².

In some embodiments, the method further includes drying the individual segments on a flat porous support by removing water to below 3% moisture.

In some embodiments, the disclosure provides a ceramic filtration module that includes: two or more individual flat segments, the two or more individual flat segments having more than one row of channels and more than one channel per row; potting material disposed around the two or more individual flat segments, the potting material holding the two or more individual flat segments together; and a housing holding the two or more individual flat segments and the potting material. The two or more individual flat segments and the potting material are disposed within the housing. The housing has at least two ports, with at least one first port being a fluid treatment entry port, and at least one second port being a treated fluid delivery port. The module has a design independent pressure decay of less than 36 mBar*liters/m²*min measured at a temperature of 25° C. when subjected to a test including: wetting the ceramic and completely removing entrained air; applying air at a pressure of 1 bar to either the at least one first or the at least one second port with the other port open to atmosphere; and turning off the air supply to the port and measuring the rate of pressure decay. In some embodiments, the design independent pressure decay is less than 18 mBar*liters/m²*min less than 18 mBar*liters/m²*min (e.g., less than 9.1 mBar*liters/m²*min, less than 4.5 mBar*liters/m²*min).

In some embodiments, the disclosure provides a method for preparing a ceramic flat segmented membrane with multiple rows of channels. The method includes: extruding one or more green bodies; and drying of the green extruded bodies on a flat porous support. The flat porous support has a porosity greater than 20% when compressed with a force of 2.45×10⁻⁵ kN/cm².

In some embodiments, the method further includes drying the one or more green bodies on a flat porous support by removing water to below 3% moisture.

In some embodiments the flat porous support has a porosity greater than 50% (e.g., between 60%-95%) when compressed with a force of 2.45×10-5 kN/cm².

In some embodiments, the disclosure provides a ceramic filtration module that includes: two or more individual flat segments, the two or more individual flat segments having more than one row of channels and more than one channel per row, the two or more individual flat segments formed of green extruded bodies dried on a flat porous support, the flat porous support having a porosity greater than porosity of greater than 20% when compressed with a force of 2.45×10⁻⁵ kN/cm²; potting material disposed around the two or more individual flat segments, the potting material holding the two or more individual flat segments together; and a housing holding the two or more individual flat segments and the potting material. The two or more individual flat segments and the potting material are disposed within the housing. The housing has at least two ports, with at least one first port being a fluid treatment entry port, and at least one second port being a treated fluid delivery port. The module has a design independent pressure decay of less than 36 mBar*liters/m²*min measured at a temperature of 25° C. when subjected to a test that includes: wetting the ceramic and completely removing entrained air; applying air at a pressure of 1 bar to either the at least one first or the at least one second port with the other port open to atmosphere; and turning off the air supply to the port and measuring the rate of pressure decay.

In some embodiments, the design independent pressure decay is less than 18 mBar*liters/m²*min (e.g., less than 9.1 mBar*liters/m²*min, less than 4.5 mBar*liters/m²*min).

These and other embodiments, aspects, advantages, and features of the present disclosure will be set forth in part in the description which follows and in the figures.

### BRIEF DESCRIPTION OF THE FIGURES

FIG. 1A illustrates a perspective view of a water filtration assembly in accordance with one or more embodiments.

FIG. 1B illustrates a cross-sectional view of a water filtration assembly taken along 1B-1B of FIG. 1A.

FIG. 2 illustrates a cross-sectional view of a water filtration assembly taken along 2-2 of FIG. 1A.

FIG. 3A illustrates a schematic diagram of drying a green extruded body on a flat porous support in accordance with one or more embodiments.

FIG. 3B illustrates a schematic diagram of drying a green extruded body on a flat porous support in accordance with one or more embodiments.

FIG. 4A illustrates a schematic diagram of drying a green extruded body without a flat porous support.

FIG. 4B illustrates a schematic diagram of drying a green extruded body without a flat porous support.

FIG. 5 illustrates a schematic diagram of an integrity test in accordance with one or more embodiments.

FIG. 6 illustrates a schematic diagram of a bubble point and permeability measurement apparatus in accordance with one or more embodiments.

FIG. 7 illustrates a schematic diagram of a FIG. 6 in flushing mode in accordance with one or more embodiments.

FIG. 8 illustrates a schematic diagram of FIG. 6 in a mode to measure permeability in accordance with one or more embodiments.

FIG. 9 illustrates a schematic diagram of FIG. 6 in a mode to conduct a bubble point test in accordance with one or more embodiments.

### DETAILED DESCRIPTION

The following detailed description includes references to the accompanying drawings, which form a part of the detailed description. The drawings show, by way of illustration, specific embodiments in which the apparatus may be practiced. These embodiments, which are also referred to herein as “examples” or “options,” are described in enough detail to enable those skilled in the art to practice the present embodiments. The embodiments may be combined, other embodiments may be utilized or structural or logical changes may be made without departing from the scope of the disclosure. The following detailed description is, therefore, not to be taken in a limiting sense and the scope of the disclosure is defined by the appended claims and their legal equivalents.

In this document, the terms “a” or “an” are used to include one or more than one, and the term “or” is used to refer to a nonexclusive “or” unless otherwise indicated. In addition, it is to be understood that the phraseology or terminology employed herein, and not otherwise defined, is for the purpose of description only and not of limitation.

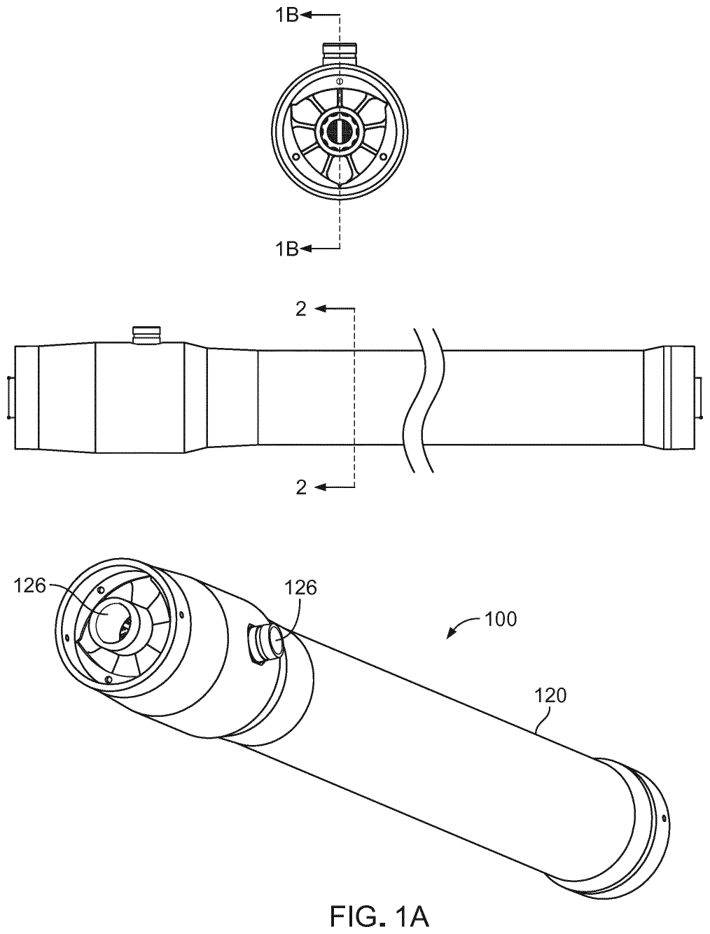

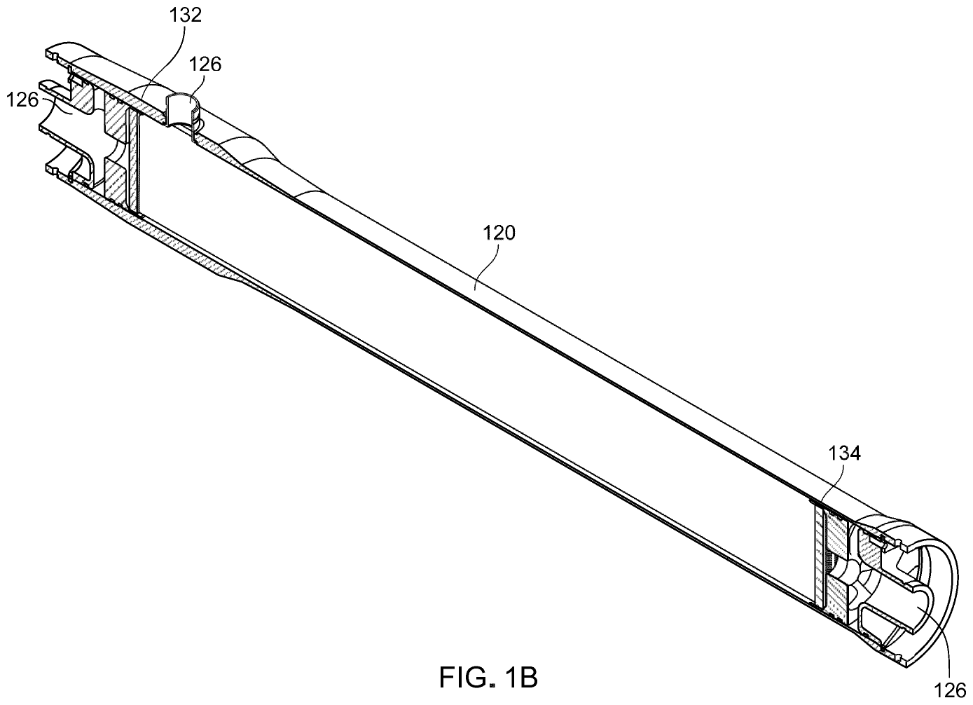

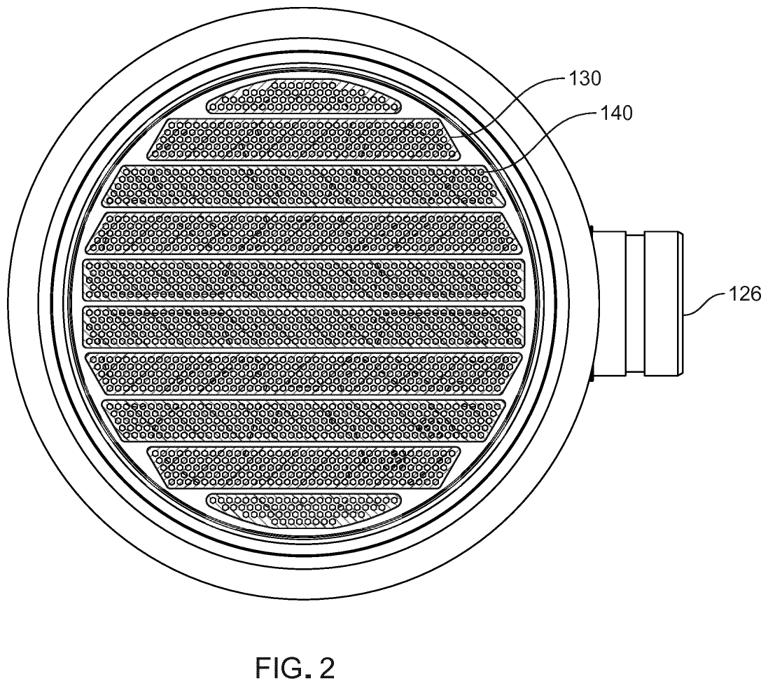

A method for preparing a ceramic, flat segmented module is described herein. A water filtration assembly, for example, a finished flat segmented module is shown in FIGS. 1A, 1B, and 2. The filtration assembly 100 includes a ceramic, flat segmented membrane module with a housing 120 and individual flat, segments 130. The flat, segments 130 comprise flat membranes that have cross-sections shown in FIG. 2, where the cross-section have at least one flat, even level surface without a slope, tile, or curvature. The flat segments has a relatively broad surface in relation to thickness or depth. One or more of the flat, segmented membranes 130 extend from a first membrane end 132 to a second membrane end 134.

Within the flat, segments 130 are channels 140. One or more of the channels 140 extend from the first membrane end 132 to the second membrane end 134. In one or more embodiments, the flat, segmented membranes have more than one row of channels and more than one channel per row. The individual segments are defined in part by an outside portion.

The flat, segments 130 are ultimately disposed in the housing 120, and potted therein with potting material. In one or more embodiments, the flat segments 130 are potted prior to being placed in the housing 120. The housing 120 holds the flat segments 130 and the potting material. The potting material is disposed to hold the flat segments 130 in a pre-determined position relative to one another. The potting material also seals off the ends of the flat segments 130 without sealing off the channels 140.

The housing 120 includes at least two ports 126. At least one port is a fluid treatment entry port, for example for untreated, dirty water. At least one port is a treated fluid delivery port for treated or purified fluids. In one or more embodiments, the ports provide a way to clean the membrane surface by pressurizing the filtrate and causing the flow direction to be temporarily reversed.

In one or more embodiments, when subjected to a predetermined air test, the ceramic, the flat segmented module has a design independent pressure decay of less than 36 mBar-liters/m²-min. In one or more embodiments, the ceramic, flat segmented module has a design independent pressure decay of less than 18 mBar-liters/m²-min. In one or more embodiments, the ceramic, flat segmented module has a design independent pressure decay of less than 9.1 mBar-liters/m²-min. In one or more embodiments, the ceramic, flat segmented module has a design independent pressure decay of less than 4.5 mBar-liters/m²-min. These levels of design independent pressure decay ensures good bacteria removal.

A good or bad pressure decay value will change from one design to another based on the hold up volume and active area. The term design independent pressure decay is converted into a value that is the same regardless of design. A design would be a configuration of membrane(s) potentially with a housing that would have a specific surface area and hold up volume. For instance, a single membrane might have 2 m² of active area and a half liter of volume that would be pressurized while the whole module would have about 22 liters of pressurized volume and 24.3 m2 of active area.

The pressure decay is a metric that gives an indication of the amount of defects in a membrane. The magnitude of the rate of air passage gives an indication of quantity of defects, and the size of the defects being determined by the pressure being applied. The measured rate of pressure decay over a period of time will also depend on the volume of air at the high pressure. A larger volume of compressed air will decay less with the same volume of air passage through defects. In use defect passage in a membrane is offset by passage of water through good regions of membrane which results in a dilution of the contaminants that may be passing through the defects. An increase in the area leads to more water passing through good regions and dilutes the relative contribution through defects. As a result of the effects of membrane area A, and pressurized volume V, the following equation can be used to determine if a given pressure decay rate D is acceptable:

D*V/A=Δ

Where Δ is the design independent pressure decay. This can be rearranged to determine an acceptable decay rate based on a specific membrane design:

D=ΔA/V

In this document A is in units of square meters, V in units of liters, and Δ in units of mBar*liters/(m²*min). Of course other units could be used with the value of Δ changing along with the units.

In one or more embodiments, the predetermined air test includes wetting the ceramic segmented membranes and completely removing entrained air from the segmented membranes, applying air at a pressure of 1 Bar to either that at least one first or the at least one second port with the other port open to atmosphere, and turning off the air support to the port and measuring the rate of pressure decay. The design independent pressure decay integrity test relates to bacterial removal. Design independent pressure decay can be measured at a pressure of around 1 Bar, and pressure loss measured over a time period. Specific pressure loss with time will depend on the volume of air during the decay measurement and can be converted with equations.

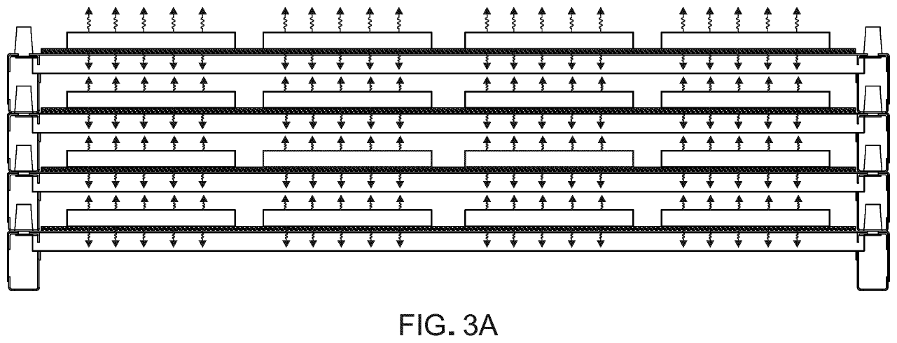

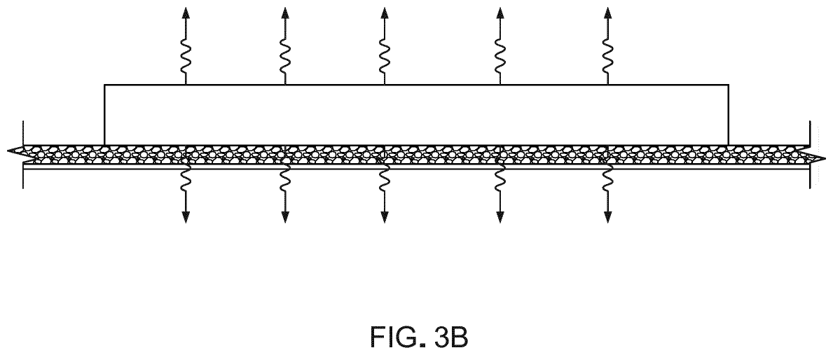

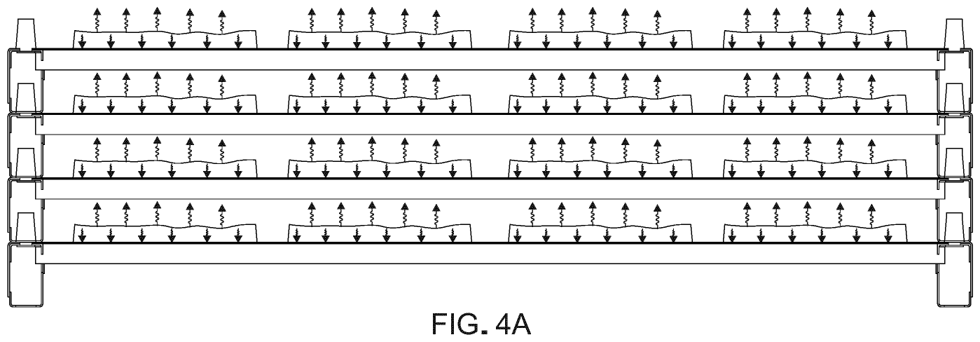

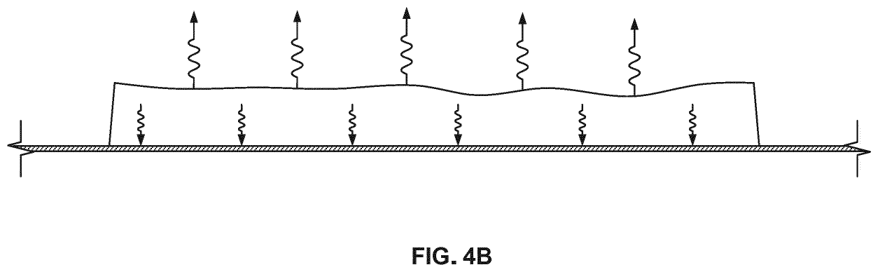

In one or more embodiments, a method for preparing a ceramic flat segmented module with multiple rows of channels includes extruding one or more green bodies. The method further includes drying the one or more green extruded bodies on a flat porous support to form multiple ceramic flat segments. As shown in FIG. 3A, 3B, drying on a flat porous support allows for the segments to remain flat (compare with FIG. 4A, 4B). In one or more embodiments, the flat porous support has a porosity of greater than 20% when compressed with a force of 2.45×10-5 kN/cm². In one or more embodiments, the flat porous support has a porosity of greater than 50% when compressed with a force of 2.45×10-5 kN/cm². In one or more embodiments, the flat porous support has a porosity between 60%-95% when compressed with a force of 2.45×10-5 kN/cm². In one or more embodiments, the flat porous material is subjected to testing to determining suitable supporting material for drying the green extruded bodies. For example, the testing can include frazier air permeability, and/or porosity. In one or more embodiments, the method drying the individual segments on a flat porous support by removing water to below 3% moisture. In one or more embodiments, the method drying the individual segments on a flat porous support by removing water to below 1% moisture.

A method for preparing the ceramic, flat segmented module includes categorizing individual segments before assembly of the flat segmented module. The individual segments are defined by an outside portion, and have more than one row of channels and more than one channel per row. The flat segmented module includes individual segments having at least one flat planar surface, and are generally flat. In one or more embodiments, the individual segments are tested for one or more defects that affect field performance, and are categorized based on the defects. For example, the categories can include one or more of design independent pressure decay results, bubble point results, or porosity and categorized as passing or failing based on the tests. Testing can be used to separate the segments into at least two categories, such as relatively defect free segments, and defect containing segments. Once the individual segments are categorized into at least two categories, individual segments from one category of the at least two categories are assembled to form assembled segments.

The assembled segments are potted together, and the potted assembled segments are disposed within a housing. The housing includes at least one first port, such as a fluid treatment entry port, and at least one second port, such as a treated fluid delivery port.

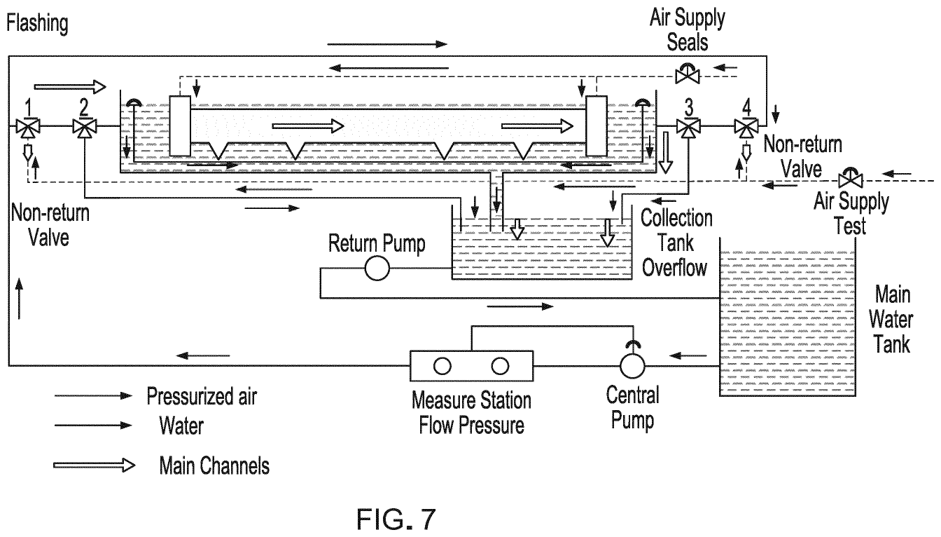

In one or more embodiments, to ensure complete modules have the highest possible integrity, individual segments can be tested before assembly into a module. The tests, include, but are not limited to, pressure decay test, bubble point test, porometery test, separation, or other tests capable of detecting low levels of defects in an individual segment prior to use in the membrane module. In one or more embodiments, testing the individual segments includes wetting at least one segment, applying to the channels air at a pressure of above 0.1 Bar to the outside portion of the segment open to atmospheric conditions. In one or more embodiments, air is applied to the channels at a pressure above 0.5 Bar. In one or more embodiments, air is applied to the channels at a pressure above 0.75 Bar. In one or more embodiments, air is applied to the channels at a pressure above 1.0 Bar. Air supply to the first end is stopped, and a rate of pressure decay in the channels is measured. See FIG. 7. In one or more embodiments, the individual segments are categorized based on a design independent pressure decay of less than 36 mBar-liters/m²-min. In one or more embodiments, the individual segments are categorized based on a design independent pressure decay of less than 18 mBar-liters/m²-min. In one or more embodiments, the individual segments are categorized based on a design independent pressure decay of less than 9.1 mBar-liters/m²-min. In one or more embodiments, the individual segments are categorized based on a design independent pressure decay of less than 4.5 mBar-liters/m²-min. For example, the individual segments are placed in one category if they satisfy the test, and in another category if the individual segments do not satisfy the test.

In one or more embodiments, testing the individual segments includes wetting the segments, immersing the segment in a test liquid, applying air to the channels, and verifying an absence of air passage at a pressure equal or greater than 0.1 bar.

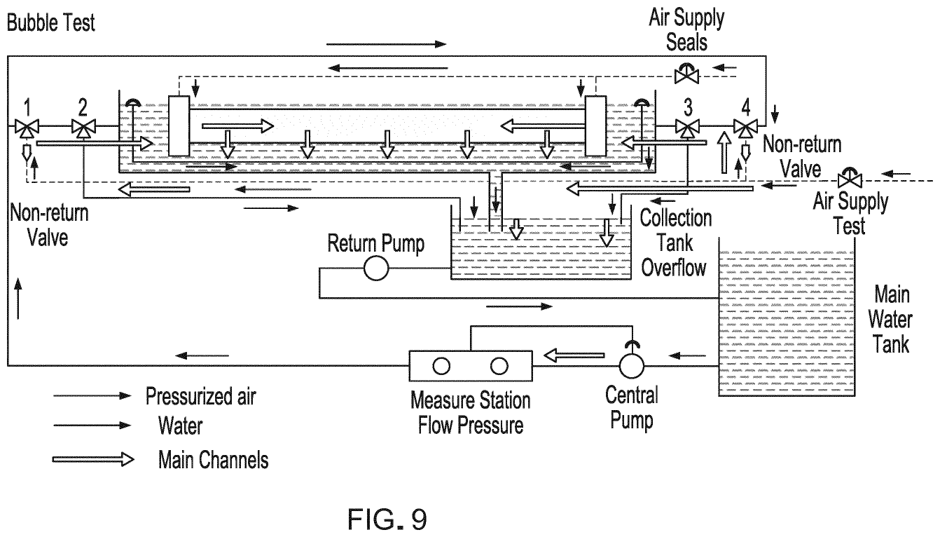

In one or more embodiments, the individual segments are categorized based on the presence or absence of air passage at a pressure equal to or greater than 0.5 bar. In one or more embodiments, the individual segments are categorized based on the presence or absence of air passage at a pressure equal to or greater than 0.7 bar. In one or more embodiments, the individual segments are categorized based on the presence or absence of air passage at a pressure of 0.9-1.1 bar. (See FIG. 9) For example, the individual segments are placed in one category if they satisfy the test, and in another category if the individual segments do not satisfy the test.

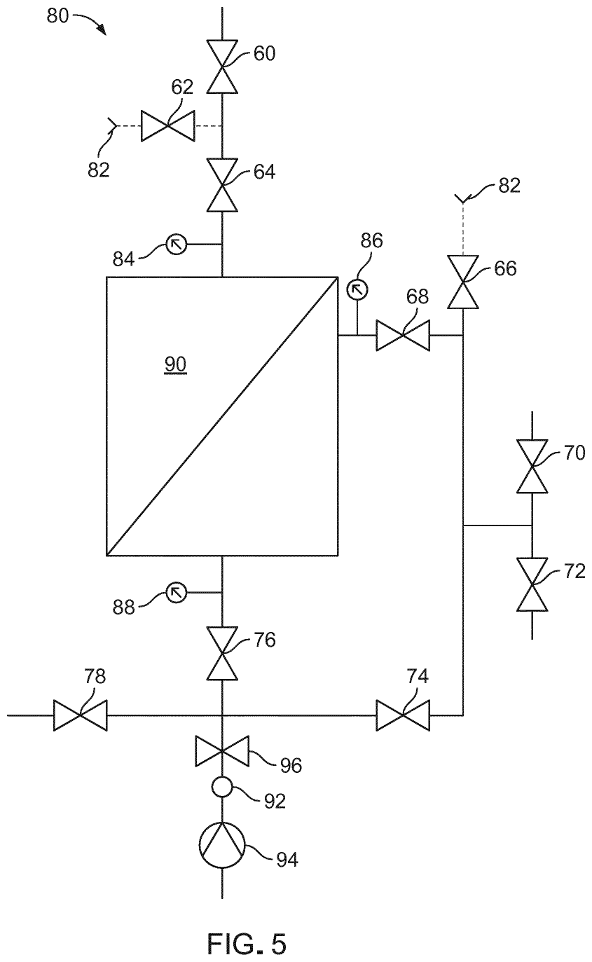

In one or more embodiments, testing the individual segments includes wetting the segments, applying air to the channels at a pressure of above 0.1 bar to the first end of the segments, the outside portion of the segments open to atmospheric conditions, and measuring a gas flow rate in the channels. In one or more embodiments, testing the individual segments includes wetting the segments, applying air to the channels at a pressure of above 0.5 bar to the first end of the segments, the outside portion of the segments open to atmospheric conditions, and measuring a gas flow rate in the channels. In one or more embodiments, testing the individual segments includes wetting the segments, applying air to the channels at a pressure of above 0.75 bar to the first end of the segments, the outside portion of the segments open to atmospheric conditions, and measuring a gas flow rate in the channels. In one or more embodiments, testing the individual segments includes wetting the segments, applying air to the channels at a pressure of above 1.0 bar to the first end of the segments, the outside portion of the segments open to atmospheric conditions, and measuring a gas flow rate in the channels. Further information on the testing is as follows. FIG. 5 shows a system 80 to conduct a Pressure Decay Integrity Test, which is a leakage test for the membrane modules/segments. The complete module/segment is wetted and set under pressure of 1.5 bar. Pressure decrease is measured over a time frame of 10 min. The maximum of design independent pressure decay is at 9.1 mBar-liters/m²-min which means an end pressure of 1.49 bar after 10 min for a module with 24.3 m² of active area and a pressurized volume of 22 liters.

The system 80 includes at least one compressed air supply 82, a concentrate pressure measuring device 84, a permeate pressure measuring device 86, a feed pressure measuring device 88, a filter element/membrane module 90, a water flow meter 92, at least one pump 94, and one or more valves configured as shown in FIG. 5. The valves include a concentrate drain valve 60, concentrate compressed air valve 62, concentrate valve 64, permeate compressed air valve 66, permeate valve 68, permeate PDIT valve 70, a permeate drain valve 72, a permeate backwash valve 74, a feed valve 76, and a feed drain valve 78, interconnected as shown in FIG. 5.

The Pressure Decay Integrity Test is completed as follows. Open valves on the top and bottom of the filter module 90 and start up the pump 94 in order to fill the channels 140 (FIG. 2). Close the top valves and open side port valve in order to fill the permeate side. Switch the system between dead end and backwash operation. The process is checked via the pressure gauges 84, 86, 88 and the flow meter 92. After the flushing sequence, shut down the pump 94 and close all valves.

After the valves are closed, compressed air is applied to the feed channels through the valve near the compressed air supply 82. After the pressure level of compressed air inside the module is reached, close valves on top of the filter element/membrane module 90, and then open the permeate valves. The next step includes allowing the pressure inside the filter element/membrane module 90 to settle for 3 minutes. After settling the pressure, the pressure decay was measured for a defined time. The pressure drop rate is calculated per minute. After pressure drop rate is calculated, pressure is released, and then air pressure is applied to the permeate side to push the water across the membrane and out of the module.

In one or more embodiments, the Pressure Decay Integrity Test (FIG. 5) can be broken down into four separate steps: flushing cycle with specific valve positions; backwash cycle with specific valve positions; test cycle with specific valve positions; and drain cycle with compressed air.

For the flushing cycle with specific valve positions, valves 62, 66, 60 and 74 are closed, all other valves are open. Water is pumped (by pump 94) into the filter membrane 90 which is intensely flushed in a first step. The water flow is controlled by measuring device 92 while flushing the membrane. The purpose of this first step is to remove all air and trapped air bubbles out of the filter membrane and the housing.

The backwash cycle is optionally done between the flushing and test cycle. Valves 74, 68, 64, and 60 are opened (all other valves are closed) and water is pumped by pump 94 in a backwash mode from the second side to the first side of the membrane.

Before the test cycle can occur, all air has to be removed out of the membrane module. The valves 64 and 68 are closed. By pump 94, the test pressure (1.5 bar) is adjusted and after that valve 76 is closed, too, and then the test cycle is started. Over a time of 10 min, the pressure within the system is observed and should not decrease more than 10 mBar/min. Pressure is measured by the devices 84, 86, and 88. Additionally, permeate valve 70 is opened to keep the permeate side on ambient pressure.

For the drain cycle, valves 62, 64, 76, and 78 are opened and module is drained with compressed air from the compressed air supply 82. This can similarly occur with opened valves 66, 68, 76, and 78 or opened valves 62, 64, 68, and 72. There are at least three possibilities to drain the system. Additionally, there is a valve 96 available to protect the pump 94 and the measuring device 92.

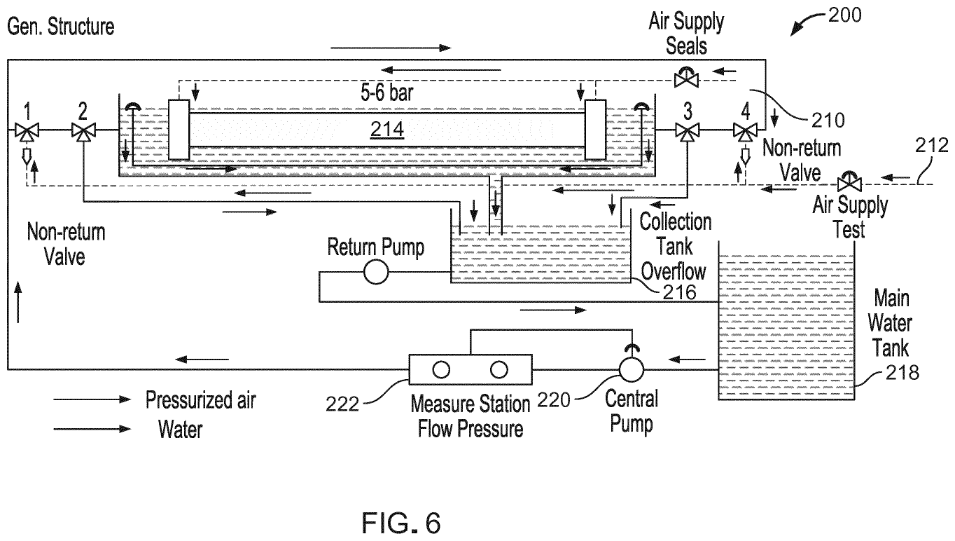

FIG. 6 relates to a general apparatus 200 for measuring bubble point and permeability. It includes an air supply 210 for sealing device, and an air supply 212 for the testing. The apparatus 200 further includes a ceramic membrane segment 214, collection tank overflow 216, and a main water tank 218. The main water tank 218 is coupled with a central pump 220 and a measuring station 222 that measures flow and pressure. FIGS. 7-9 show the same apparatus but in different operating modes.

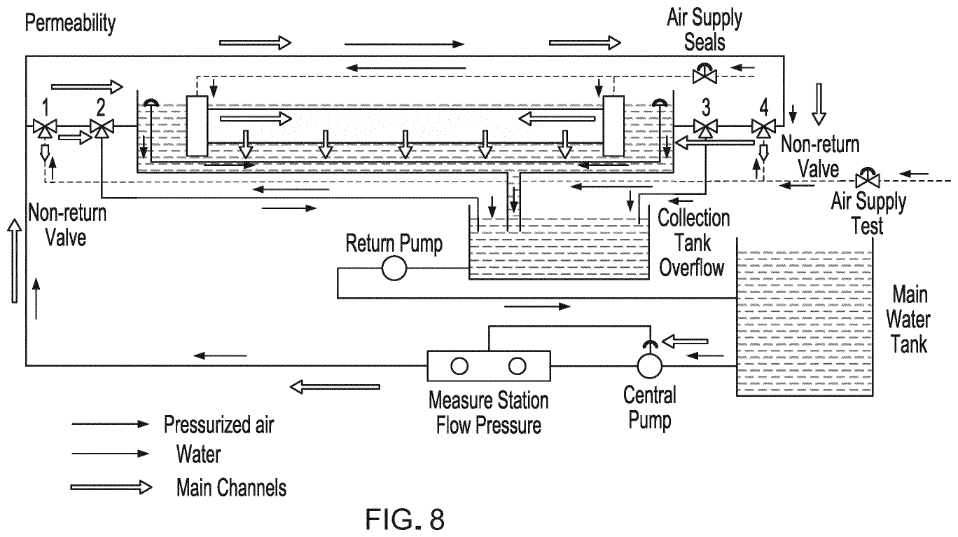

For example, FIG. 7 illustrates the same apparatus as FIG. 6, but is in flushing mode to remove air from the ceramic membrane segments and wet them completely. FIG. 8 illustrates the testing apparatus for the measurement of permeability (1/hm² bar with 0.4 Bar). The segments can be categorized based on the permeability of the segments.

FIG. 9 illustrates the bubble point test. In one or more embodiments, the test begins with 0.4 bar, and pressure is increased every 30 s by 0.1 bar until an end pressure of 1.6 bar. As soon as air bubbles occur on the surface of the segments, pressure is determined. In one or more embodiments, segments with a bubble point greater than or equal to 1.1 bar are categorized as passing segments. In one or more embodiments, segments with a bubble point lesser than 1.1 bar are categorized as failing segments.

Advantageously, the pre-selection of defect reduced segments greatly reduced the number of defects for the ceramic module, and allows for the module to be prepared with improved integrity. Furthermore, by supporting flat green bodies on a porous material during drying, the segments can be prepared free of defects by allowing evaporation from top and bottom surfaces.

It is to be understood that the above description is intended to be illustrative, and not restrictive. Many other embodiments will be apparent to those of skill in the art upon reading and understanding the above description. It should be noted that embodiments discussed in different portions of the description or referred to in different drawings can be combined to form additional embodiments of the present application. The scope should, therefore, be determined with reference to the appended claims, along with the full scope of equivalents to which such claims are entitled.

### EMBODIMENTS

Although the present invention is defined in the attached claims, it should be understood that the present invention can also (alternatively) be defined in accordance with the following embodiments:

1. A module, comprising:

at least two individual flat ceramic segments comprising rows of channels with more than one channel per row;

potting material holding the at least two individual flat ceramic segments together; and

a housing holding the at least two individual flat ceramic segments and the potting material,

wherein:
the housing, potting material and at least two individual flat segments define a filtration module; and
the module is configured to be capable of providing a design independent pressure decay of less than 36 mBar*liters/m²*min when measured according to the following test method:
   wetting the ceramic and completely removing entrained air;
   applying air at a pressure of 1 bar to a port of the housing; and
   turning off the air supply to the port and measuring the design independent pressure decay in the channels a temperature of 25° C.
      2. The module of embodiment 1, wherein the module is configured to be capable of providing a design independent pressure decay of less than 18 mBar*liters/m²*min according to the test method.
      3. The module of embodiment 1, wherein the module is configured to be capable of providing a design independent pressure decay of less than 9.1 mBar*liters/m²*min according to the test method.
      4. The module of embodiment 1, wherein the module is configured to be capable of providing a design independent pressure decay of less than 4.5 mBar*liters/m²*min.
      5. A monolithic filtration module comprising a plurality of separate ceramic segments held in a housing via a potting material, wherein the module is configured to be capable of providing a design independent pressure decay of less than 36 mBar*liters/m²*min when measured according to the following method:

wetting the ceramic and completely removing entrained air;

applying air at a pressure of 1 bar to a port of the housing; and

turning off the air supply to the port and measuring the design independent pressure decay in the channels a temperature of 25° C.

6. The module of embodiment 5, wherein the module is configured to be capable of providing a design independent pressure decay of less than 18 mBar*liters/m²*min.
7. The module of embodiment 5, wherein the module is configured to be capable of providing a design independent pressure decay of less than 9.1 mBar*liters/m²*min.
8. The module of embodiment 5, wherein the module is configured to be capable of providing a design independent pressure decay of less than 4.5 mBar*liters/m²*min.
9. A module, comprising:

at least two individual flat ceramic segments comprising rows of channels with more than one channel per row;

potting material holding the at least two individual flat ceramic segments together; and

a housing holding the at least two individual flat ceramic segments and the potting material,

wherein:
the housing, potting material and at least two individual flat segments define a filtration module; and
the module is configured to be capable of providing a design independent pressure decay of less than 36 mBar*liters/m²*min when measured according to the following method:
   wetting the segments;
   applying air to the channels at a pressure of above 0.1 bar when an outside portion of the segments is open to atmospheric conditions;
   stopping air supply to the channels; and
   measuring the design independent pressure decay through the segments at a temperature of 25° C.
      10. The module of embodiment 9, wherein the module is configured to be capable of providing a design independent pressure decay of less than 18 mBar*liters/m²*min.
      11. The module of embodiment 9, wherein the module is configured to be capable of providing a design independent pressure decay of less than 9.1 mBar*liters/m²*min.
      12. The module of embodiment 9, wherein the module is configured to be capable of providing a design independent pressure decay of less than 4.5 mBar*liters/m²*min.
      13. The module of embodiment 9, wherein the method includes applying air to the channels at a pressure of above 0.5 bar when an outside portion of the segments is open to atmospheric conditions.
      14. The module of embodiment 9, wherein the method includes applying air to the channels at a pressure of above 0.75 bar when an outside portion of the segments is open to atmospheric conditions.
      15. The module of embodiment 9, wherein the method includes applying air to the channels at a pressure of above 1.0 bar when an outside portion of the segments is open to atmospheric conditions.
      16. A monolithic filtration module comprising a plurality of separate ceramic segments held in a housing via a potting material, wherein the module is configured to be capable of providing a design independent pressure decay of less than 36 mBar*liters/m²*min when measured according to the following method:

wetting the segments;

applying air to the channels at a pressure of above 0.1 bar when an outside portion of the segments is open to atmospheric conditions;

stopping air supply to the channels; and

measuring the design independent pressure decay through the segments at a temperature of 25° C.

17. The module of embodiment 16, wherein the module is configured to be capable of providing a design independent pressure decay of less than 18 mBar*liters/m²*min.
18. The module of embodiment 16, wherein the module is configured to be capable of providing a design independent pressure decay of less than 9.1 mBar*liters/m²*min.
19. The module of embodiment 16, wherein the module is configured to be capable of providing a design independent pressure decay of less than 4.5 mBar*liters/m²*min.
20. The module of embodiment 16, wherein the method includes applying air to the channels at a pressure of above 0.5 bar when an outside portion of the segments is open to atmospheric conditions.
21. The module of embodiment 16, wherein the method includes applying air to the channels at a pressure of above 0.75 bar when an outside portion of the segments is open to atmospheric conditions.
22. The module of embodiment 16, wherein the method includes applying air to the channels at a pressure of above 1.0 bar when an outside portion of the segments is open to atmospheric conditions.
23. A method for preparing a ceramic, flat segmented module having individual segments, the individual segments having more than one row of channels and more than one channel per row, the individual segments defined by an outside portion, the method comprising:

categorizing individual segments into at least two categories based on occurrence of defects that affect field performance, where categorizing the segments occurs before assembly of the segments, each of the segments extending from a first end to a second end;

assembling the individual segments primarily from one category of the at least two categories and forming assembled segments;

potting the assembled segments together; and

disposing the potted segments into a housing with at least two ports, at least one first port is a fluid treatment entry port, at least one second port is a treated fluid delivery port.

24. The method as recited in embodiment 23, further comprising testing the individual segments prior to categorizing the individual segments.
25. The method as recited in embodiment 24, wherein testing the individual segments includes wetting the segments, applying air to the channels at a pressure of above 0.1 bar to the channels, the outside portion of the segments is open to atmospheric conditions, stopping air supply to the channels, and measuring a rate of pressure decay in the channels.
26. The method as recited in embodiment 25, wherein the individual segments are categorized based on a design independent pressure decay of less than 36 mBar*liters/m²*min at a temperature of 25° C.
27. The method as recited in embodiment 25, wherein the individual segments are categorized based on a design independent pressure decay of less than 18 mBar*liters/m²*min at a temperature of 25° C.
28. The method as recited in embodiment 25, wherein the individual segments are categorized based on a design independent pressure decay of less than 9.1 mBar*liters/m²*min at a temperature of 25° C.
29. The method as recited in embodiment 25, wherein the individual segments are categorized based on a design independent pressure decay of less than 4.5 mBar*liters/m²*min at a temperature of 25° C.
30. The method as recited in embodiment 24, wherein testing the individual segments includes wetting the segments, applying air to the channels at a pressure of above 0.1 bar to the first end of the segments, the outside portion of the segments is open to atmospheric conditions, and measuring a gas flow rate in the channels.
31. The method as recited in embodiment 24, wherein testing the individual segments includes wetting the segments, immersing the segment in a test liquid, applying air to the channels, and verifying an absence of air passage at a pressure equal or greater than 0.1 Bar.
32. The method as recited in embodiment 31, wherein the individual segments are categorized based on the presence or absence of air passage at a pressure equal or greater than 0.5 Bar.
33. The method as recited in embodiment 31, wherein the individual segments are categorized based on the presence or absence of air passage at a pressure equal or greater than 0.7 Bar.
34. The method as recited in embodiment 31, wherein the individual segments are categorized based on the presence or absence of air passage at a pressure equal or greater than 0.9-1.1 Bar.
35. The method as recited in embodiment 24, further comprising drying the individual segments on a flat porous support having a porosity of greater than 20% when compressed with a force of 2.45×10⁻⁵ kN/cm².
36. The method as recited in embodiment 24, further comprising drying the individual segments on a flat porous support having a porosity of greater than 50% when compressed with a force of 2.45×10⁻⁵ kN/cm².
37. The method as recited in embodiment 24, further comprising drying the individual segments on a flat porous support having a porosity of 60%-95% when compressed with a force of 2.45×10⁻⁵ kN/cm².
38. The method as recited in embodiment 24, further comprising drying the individual segments on a flat porous support by removing water to below 3% moisture.
39. A ceramic filtration module comprising:

two or more individual flat segments, the two or more individual flat segments having more than one row of channels and more than one channel per row;

potting material disposed around the two or more individual flat segments, the potting material holding the two or more individual flat segments together; and

a housing holding the two or more individual flat segments and the potting material, the two or more individual flat segments and the potting material disposed within the housing;

the housing having at least two ports, at least one first port is a fluid treatment entry port, at least one second port is a treated fluid delivery port; and

wherein the module has a design independent pressure decay of less than 36 mBar*liters/m²*min measured at a temperature of 25° C. when subjected to a test comprising:
wetting the ceramic and completely removing entrained air;
applying air at a pressure of 1 bar to either the at least one first or the at least one second port with the other port open to atmosphere; and
turning off the air supply to the port and measuring the rate of pressure decay.
   40. The module of embodiment 39, wherein the design independent pressure decay is pressure decay is less than 18 mBar*liters/m²*min.
   41. The module of embodiment 39, wherein the design independent pressure decay is less than 9.1 mBar*liters/m²*min.
   42. The module of embodiment 39, wherein the design independent pressure decay is less than 4.5 mBar*liters/m²*min.
   43. A method for preparing a ceramic flat segmented membrane with multiple rows of channels, the method comprising:

extruding one or more green bodies; and

drying of the green extruded bodies on a flat porous support, the flat porous support having a porosity greater than 20% when compressed with a force of 2.45×10⁻⁵ kN/cm².

44. The method as recited in embodiment 43, further comprising drying the one or more green bodies on a flat porous support by removing water to below 3% moisture.
45. The method as recited in embodiment 43, wherein the flat porous support having a porosity greater than 50% when compressed with a force of 2.45×10-5 kN/cm².
46. The method as recited in embodiment 43, wherein the flat porous support having a porosity between 60%-95% when compressed with a force of 2.45×10-5 kN/cm².
47. A ceramic filtration module comprising;

two or more individual flat segments, the two or more individual flat segments having more than one row of channels and more than one channel per row, the two or more individual flat segments formed of green extruded bodies dried on a flat porous support, the flat porous support having a porosity greater than porosity of greater than 20% when compressed with a force of 2.45×10⁻⁵ kN/cm²;

potting material disposed around the two or more individual flat segments, the potting material holding the two or more individual flat segments together;

a housing holding the two or more individual flat segments and the potting material, the two or more individual flat segments and the potting material disposed within the housing;

the housing having at least two ports, at least one first port is a fluid treatment entry port, at least one second port is a treated fluid delivery port; and

wherein the module has a design independent pressure decay of less than 36 mBar*liters/m²*min measured at a temperature of 25° C. when subjected to a test comprising:
wetting the ceramic and completely removing entrained air;
applying air at a pressure of 1 bar to either the at least one first or the at least one second port with the other port open to atmosphere; and
turning off the air supply to the port and measuring the rate of pressure decay.
   48. The module of embodiment 47, wherein the design independent pressure decay is less than 18 mBar*liters/m²*min.
   49. The module of embodiment 47, wherein the design independent pressure decay is less than 9.1 mBar*liters/m²*min.
   50. The module of embodiment 47, wherein the design independent pressure decay is less than 4.5 mBar*liters/m²*min.

1.-25. (canceled)

26. A filtration module comprising a plurality of separate ceramic segments held in a housing via a potting material, wherein the module is configured to be capable of providing a design independent pressure decay of less than 36 mBar*liters/m²*min when measured according to the following method:
wetting the ceramic and completely removing entrained air;
applying air at a pressure of 1 bar to a port of the housing; and
turning off the air supply to the port and measuring the design independent pressure decay in the channels a temperature of 25° C.

27. The module of claim 26, wherein the method comprises:
wetting the segments;
applying air to the channels at a pressure of above 0.1 bar when an outside portion of the segments is open to atmospheric conditions;
stopping air supply to the channels; and
measuring the design independent pressure decay through the segments at a temperature of 25° C.

28. The module of claim 26, wherein the module is configured to be capable of providing a design independent pressure decay of less than 18 mBar*liters/m²*min.

29. The module of claim 28, wherein the method includes applying air to the channels at a pressure of above 0.5 bar when an outside portion of the segments is open to atmospheric conditions.

30. The module of claim 26, comprising:
at least two individual flat ceramic segments comprising rows of channels with more than one channel per row;
potting material holding the at least two individual flat ceramic segments together; and
a housing holding the at least two individual flat ceramic segments and the potting material,
wherein the housing, potting material and at least two individual flat segments define a filtration module.

31. The module of claim 30, wherein the module is configured to be capable of providing a design independent pressure decay of less than 18 mBar*liters/m²*min according to the test method.

32. The module of claim 26, comprising:
two or more individual flat segments, the two or more individual flat segments having more than one row of channels and more than one channel per row;
potting material disposed around the two or more individual flat segments, the potting material holding the two or more individual flat segments together; and
a housing holding the two or more individual flat segments and the potting material, the two or more individual flat segments and the potting material disposed within the housing; and
the housing having at least two ports, at least one first port is a fluid treatment entry port, at least one second port is a treated fluid delivery port.

33. The module of claim 32, wherein the two or more individual flat segments are formed of green extruded bodies dried on a flat porous support, the flat porous support having a porosity greater than porosity of greater than 20% when compressed with a force of 2.45×10⁻⁵ kN/cm².

34. A method for preparing a ceramic, flat segmented module having individual segments, the individual segments having more than one row of channels and more than one channel per row, the individual segments defined by an outside portion, the method comprising:
categorizing individual segments into at least two categories based on occurrence of defects that affect field performance, where categorizing the segments occurs before assembly of the segments, each of the segments extending from a first end to a second end;
assembling the individual segments primarily from one category of the at least two categories and forming assembled segments;
potting the assembled segments together; and
disposing the potted segments into a housing with at least two ports, at least one first port is a fluid treatment entry port, at least one second port is a treated fluid delivery port.

35. The method as recited in claim 34, further comprising testing the individual segments prior to categorizing the individual segments.

36. The method as recited in claim 34, wherein testing the individual segments includes wetting the segments, applying air to the channels at a pressure of above 0.1 bar to the channels, the outside portion of the segments is open to atmospheric conditions, stopping air supply to the channels, and measuring a rate of pressure decay in the channels.

37. The method as recited in claim 34, wherein the individual segments are categorized based on a design independent pressure decay of less than 36 mBar*liters/m²*min at a temperature of 25° C., preferably less than 18 mBar*liters/m²*min at a temperature of 25° C.

38. The method as recited in claim 34, wherein testing the individual segments includes wetting the segments, applying air to the channels at a pressure of above 0.1 bar to the first end of the segments, the outside portion of the segments is open to atmospheric conditions, and measuring a gas flow rate in the channels.

39. The method as recited in claim 34, wherein testing the individual segments includes wetting the segments, immersing the segment in a test liquid, applying air to the channels, and verifying an absence of air passage at a pressure equal or greater than 0.1 Bar.

40. The method as recited in claim 39, wherein the individual segments are categorized based on the presence or absence of air passage at a pressure equal or greater than 0.5 Bar.

41. The method as recited in claim 34, further comprising drying the individual segments on a flat porous support having a porosity of greater than 20% when compressed with a force of 2.45×10⁻⁵ kN/cm².

42. The method as recited in claim 34, further comprising drying the individual segments on a flat porous support by removing water to below 3% moisture.

43. A method for preparing a ceramic flat segmented membrane with multiple rows of channels, the method comprising:
extruding one or more green bodies; and
drying of the green extruded bodies on a flat porous support, the flat porous support having a porosity greater than 20% when compressed with a force of 2.45×10⁻⁵ kN/cm².

44. The method as recited in claim 43, further comprising drying the one or more green bodies on a flat porous support by removing water to below 3% moisture.

45. The method as recited in claim 43, wherein the flat porous support having a porosity greater than 50% when compressed with a force of 2.45×10-5 kN/cm².
